(19) United States
(12) Patent Application Publication
(10) Pub. No.: US 2023/0226788 A1
(43) Pub. Date: Jul. 20, 2023

(54) SYSTEM AND METHOD FOR MANUFACTURING A COMPOSITE STRUCTURE

(71) Applicant: General Electric Company, Schenectady, NY (US)

(72) Inventors: James Robert Tobin, Greenville, SC (US); Paul Trevor Hayden, Romsey (GB); Harald Behmer, Newport (GB); Raphael Sajous, Cowes (GB); Hongyi Zhou, Schenectady, NY (US)

(21) Appl. No.: 18/011,217

(22) PCT Filed: Jun. 24, 2021
(86) PCT No.: PCT/US2021/038809

§ 371 Date: Dec. 19, 2022

Related U.S. Application Data
(60) Provisional application No. 63/043,184, filed on Jun. 24, 2020.
(60) Provisional application No. 63/043,191, filed on Jun. 24, 2020.
(60) Provisional application No. 63/043,200, filed on Jun. 24, 2020.

(51) Int. Cl. B29D 99/00; B33Y 80/00; B33Y 10/00

(52) U.S. Cl. CPC B29D 99/0028; B33Y 80/00; B29D 99/0014; B33Y 10/00

(57) ABSTRACT

In an aspect, the present disclosure is directed to a composite structure. The composite structure includes a three-dimensional (3-D) grid structure and at least one monolithic skin layer at least partially enveloping and securing the grid structure. As such, the grid structure is configured to stabilize the composite structure under at least one of: static local buckling and dynamic global buckling.

### CROSS-REFERENCE TO RELATED APPLICATIONS

The present application claims priority to PCT Application Serial Number PCT/US2021/038809, filed Jun. 24, 2021, which claims the benefit of U.S. Provisional Patent Application Nos. 63/043,184, 63/043,191, and 63/043,200, all three filed on Jun. 24, 2020. All of the applications are incorporated by reference herein in their entirety.

### STATEMENT REGARDING FEDERALLY SPONSORED RESEARCH OR DEVELOPMENT

This invention was made with Government support under DE-EE0009403 awarded by DOE. The Government has certain rights in this invention.

### FIELD

The present disclosure relates in general to methods and apparatuses of manufacturing composite structures, such as rotor blades.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more structural components (e.g., opposing spar caps with a shear web configured therebetween) that engage the inner pressure and suction side surfaces of the shell halves.

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together, e.g., with a thermoset resin. Accordingly, conventional rotor blades generally have a sandwich panel configuration. As such, conventional blade manufacturing of large rotor blades involves high labor costs, slow through put, and low utilization of expensive mold tooling. Further, the blade molds can be expensive to customize.

Thus, methods for manufacturing rotor blades may include forming the rotor blades in segments. The blade segments may then be assembled on or off site to form the rotor blade. For example, some modern rotor blades, such as those blades described in U.S. patent application Ser. No. 14/753,137 filed Jun. 29, 2015, and entitled “Modular Wind Turbine Rotor Blades and Methods of Assembling Same,” which is incorporated herein by reference in its entirety, have a modular panel configuration. Thus, the various blade components of the modular rotor blade can be constructed of varying materials based on the function and/or location of the blade component.

In view of the foregoing, the art is continually seeking new and improved rotor blades and methods for manufacturing and/or assembling such rotor blades and associated components.

### BRIEF DESCRIPTION

Aspects and advantages of the invention will be set forth in part in the following description, or may be obvious from the description, or may be learned through practice of the invention.

In an aspect, the present disclosure is directed to a method of manufacturing a composite structure. The method includes placing at least one fabric layer atop a generally flat mold. The method also includes placing at least one thermoplastic film in one or more desired locations adjacent to the at least one fabric layer. Further, the method includes co-infusing or co-bonding the at least one fabric layer and the at least one thermoplastic film together atop the generally flat mold to form at least one skin layer having a resin-rich, print-side surface, wherein the at least one skin layer comprises a thermoplastic resin after curing. Moreover, the method includes forcing the at least one skin layer into a desired shape via a curved mold. In addition, the method includes printing and depositing, via an extruder of a computer numerical control (CNC) device, a liquid thermoplastic material onto the resin-rich, print-side surface of the curved at least one skin layer to form a three-dimensional grid structure thereon. The method also includes at least partially enveloping and securing the grid structure within the at least one fabric layer to form the composite structure.

In another aspect, the present disclosure is directed to a method of manufacturing a composite structure. The method includes placing at least one fabric layer atop a generally flat mold. The method also includes infusing the at least one fabric layer with an infusible thermoplastic resin material atop the generally flat mold to form one or more resin-rich, print-side areas on the at least one fabric layer. Further, the method includes forcing the composite structure into a desired shape via a curved mold. In addition, the method includes printing and depositing, via an extruder of a computer numerical control (CNC) device, a liquid thermoplastic material onto the resin-rich, print-side surface to form the composite structure having a three-dimensional grid structure thereon. Moreover, the method includes at least partially enveloping and securing the grid structure within the at least one fabric layer.

In yet another aspect, the present disclosure is directed to a composite structure. The composite structure includes at least one skin layer constructed of an infusible thermoplastic resin material and one or more fiber fabrics and at least one thermoplastic film co-infused or co-bonded with the at least one skin layer to form a resin-rich, print-side surface on the at least one skin layer. The composite structure also includes a three-dimensional (3-D) grid structure secured to the resin-rich, print-side surface on the at least one skin layer, the at least one skin layer at least partially enveloping and securing the grid structure. As such, the grid structure is configured to stabilize the composite structure under at least one of: static local buckling and dynamic global buckling.

In a further aspect, the present disclosure is directed to a composite structure. The composite structure includes at least one skin layer constructed of an infusible thermoplastic resin material and one or more fiber fabrics, the at least one skin layer having a resin-rich, print-side surface, and a three-dimensional (3-D) grid structure secured to the resin-rich, print-side surface on the at least one skin layer, the at least one skin layer at least partially enveloping and securing the grid structure. As such, the grid structure is configured to stabilize the composite structure under at least one of: static local buckling and dynamic global buckling.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to an aspect of the present disclosure;

FIG. 2 illustrates a perspective view of one embodiment of a composite structure according to an aspect of the present disclosure;

FIG. 3 illustrates an exploded view of the composite structure of FIG. 2;

FIG. 4 illustrates a cross-sectional view of one embodiment of a leading edge segment of a composite structure according to an aspect of the present disclosure;

FIG. 5 illustrates a cross-sectional view of one embodiment of a trailing edge segment of a composite structure according to an aspect of the present disclosure;

FIG. 6 illustrates a cross-sectional view of the composite structure of FIG. 2 according to an aspect of the present disclosure along line 6-6;

FIG. 7 illustrates a cross-sectional view of the composite structure of FIG. 2 according to an aspect of the present disclosure along line 7-7;

FIG. 8 illustrates a flow diagram of one embodiment of a method of manufacturing the composite structure, such as the composite structure generally illustrated in FIGS. 2-7, according to the present disclosure;

FIG. 9A illustrates a simplified, perspective view of one embodiment of a flat mold table having flat fabrics laid thereon according to the present disclosure;

FIG. 9B illustrates a simplified, cross-sectional view of the flat fabrics of FIG. 9A;

FIG. 9C illustrates a simplified, side view of another embodiment of a mold table having a trough formed therein according to the present disclosure;

FIG. 10 illustrates a simplified, side view of one embodiment of a vacuum infusion process according to the present disclosure;

FIG. 11 illustrates a simplified, side view of another embodiment of a vacuum infusion process according to the present disclosure;

FIG. 12 illustrates a simplified, side view of yet another embodiment of a vacuum infusion process according to the present disclosure;

FIG. 13A illustrates a simplified, side view of one embodiment of a pre-heated curved mold according to the present disclosure;

FIG. 13B illustrates a simplified, side view of the pre-heated curved mold of FIG. 13A, with the flat fabrics forced into a desired shape therein;

FIG. 13C illustrates a perspective view of one embodiment of an additive printing device arranged above a curved mold according to the present disclosure;

FIG. 13D illustrates a perspective view of the additive printing device of FIG. 13C, with the device printing a grid structure according to the present disclosure;

FIG. 14 illustrates a perspective view of one embodiment of a composite structure manufactured according to the present disclosure; and

FIG. 15 illustrates a flow diagram of another embodiment of a method of manufacturing the composite structure, such as the composite structure generally illustrated in FIGS. 2-7, according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to an apparatus and method for manufacturing a composite structure, including structures thereof, using vacuum infusion and automated deposition of materials via technologies such as 3-D Printing, additive manufacturing, automated fiber deposition or tape deposition, as well as other techniques that utilize CNC control and multiple degrees of freedom to deposit material. The apparatus generally includes a flat mold onto which skins of the composite structure are formed, e.g., via vacuum infusion. The formed skins are then forced into a curved mold to form a desired shape, such as a curved rotor blade. One or more stabilizing grid structures can then be formed separately or printed directly onto the formed skins to form the composite structure.

Thus, the methods described herein provide many advantages not present in the prior art. For example, the embodiments of the present disclosure described herein may improve manufacturing cycle time efficiency. For example, the methods of the present disclosure may provide the ability to easily customize composite structure structures having various curvatures, aerodynamic characteristics, strengths, stiffness, etc. For example, the printed or formed structures of the present disclosure can be designed to match the stiffness and/or buckling resistance of existing sandwich panels for composite structures. More specifically, composite structures defining the exemplary rotor blades and components thereof generally provided in the present disclosure can be more easily customized based on the local buckling resistance needed. Still further advantages include the ability to locally and temporarily buckle to reduce loads and/or tune the resonant frequency of the rotor blades to avoid problem frequencies. Moreover, the structures described herein enable bend-twist coupling of the composite structure, such as defining a rotor blade. Furthermore, improved methods of manufacturing, and improve manufacturing cycle time associated therewith, for the improved customized composite structure structures may thereby enable cost-efficient production and availability of composite structures, including, but not limited to, rotor blades described herein, such as through a higher level of automation, faster throughput, and reduced tooling costs and/or higher tooling utilization. Further, the composite structures of the present disclosure may not require adhesives, especially those produced with thermoplastic materials, thereby eliminating cost, quality issues, and extra weight associated with bond paste.

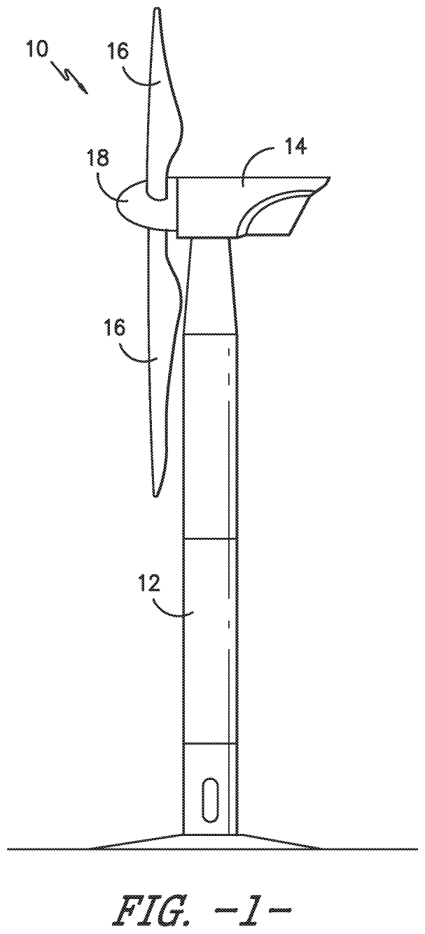

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to wind turbines or any particular type of wind turbine configuration. In addition, the present invention is not limited to use with wind turbines, but may be utilized in producing any composite structure, such as any application having rotor blades. Further, the methods described herein may also apply to manufacturing any composite structure that benefits from printing or laying a structure to a mold. Still further, the methods described herein may further apply to manufacturing any composite structure that benefits from printing or laying a structure onto a skin placed onto a mold, which may include, but is not limited to, before the skins have cooled so as to take advantage of the heat from the skins to provide adequate bonding between the printed structure and the skins. As such, the need for additional adhesive or additional curing is eliminated.

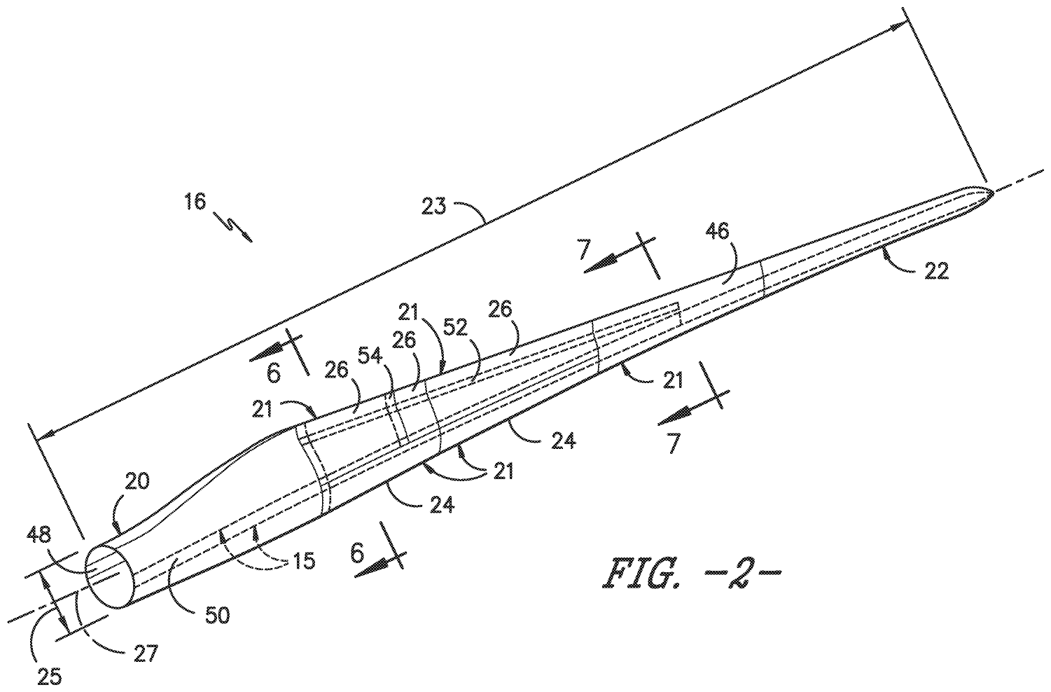

Referring now to FIGS. 2 and 3, various views of an exemplary composite structure that may be produced by the structures, apparatuses, and methods generally provided herein according to the present disclosure are illustrated. More specifically, an exemplary embodiment of a composite structure defining a rotor blade 16 is generally provided. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 constructed, at least in part, from a thermoset and/or a thermoplastic material and at least one blade segment 21 configured with the main blade structure 15. More specifically, as shown, the rotor blade 16 includes a plurality of blade segments 21. The blade segment(s) 21 may also be constructed, at least in part, from a thermoset and/or a thermoplastic material.

The thermoplastic rotor blade components and/or materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PETG), polycarbonate (PC), polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

In addition, certain thermoplastic resins provided herein, such as PMMA and polyamides, for example, can be impregnated into structural fabrics via infusion via VARTM or other suitable infusion methods known in the art. One example of an infusible PMMA based resin system may be Elium® from Arkema Corporation. In such embodiments, infusible thermoplastics can be infused into fabrics/fiber materials as a low viscosity mixture of resin(s) and catalyst. Thus, upon curing, infusible thermoplastic resins form a thermoplastic matrix in situ to make a fiber-reinforced composite. The resulting thermoplastic-based composite is thermally reversible, unlike thermoset resins. An advantage of using infusible thermoplastics over other methods of making thermoplastic fiber reinforced laminates is the reduction in capital equipment needed for methods that require large presses to manufacture large scale laminates needed to be applicable to many wind blade components.

Further, the thermoset components and/or materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

In addition, as mentioned, the thermoplastic and/or the thermoset material as described herein may optionally be reinforced with a fiber material, including but not limited to glass fibers, carbon fibers, polymer fibers, wood fibers, bamboo fibers, ceramic fibers, nanofibers, metal fibers, basalt fibers, or similar or combinations thereof. In addition, the direction of the fibers may include multi-axial, unidirectional, biaxial, triaxial, or any other another suitable direction and/or combinations thereof. Further, the fiber content may vary depending on the stiffness required in the corresponding blade component, the region or location of the blade component in the rotor blade 16, and/or the desired weldability of the component.

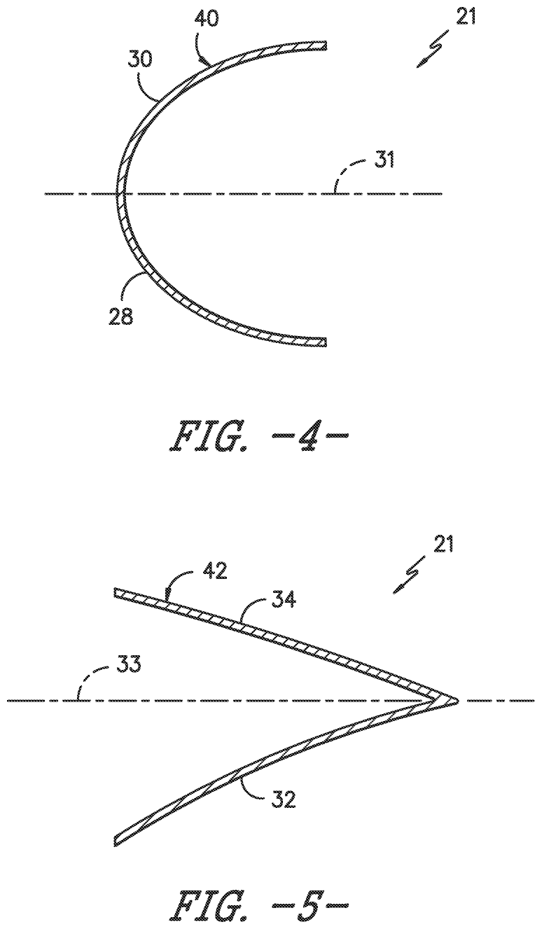

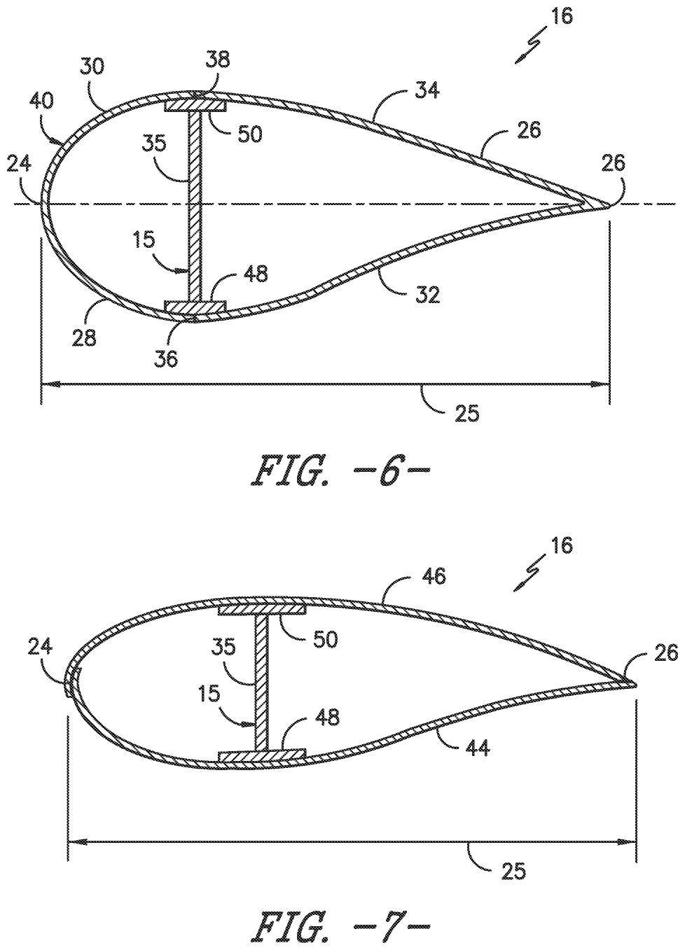

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a length or span 23 that is equal to the total length between the blade root section 20 and the blade tip section 22. As shown in FIGS. 2 and 6, the rotor blade 16 also defines a width or chord 25 that is equal to the total length between a leading edge 24 of the rotor blade 16 and a trailing edge 26 of the rotor blade 16. As is generally understood, the width or chord 25 may generally vary in length with respect to the length or span 23 as the rotor blade 16 extends from the blade root section 20 to the blade tip section 22.

Referring particularly to FIGS. 2-4, any number of blade segments 21 or panels having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section. In additional embodiments, it should be understood that the blade segment portion of the blade 16 may include any combination of the segments described herein and are not limited to the embodiment as depicted. In addition, the blade segments 21 may be constructed of any suitable materials, including but not limited to a thermoset material or a thermoplastic material optionally reinforced with one or more fiber materials. More specifically, in certain embodiments, the blade panels 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi jointed blade segment, a J-shaped blade segment, or similar.

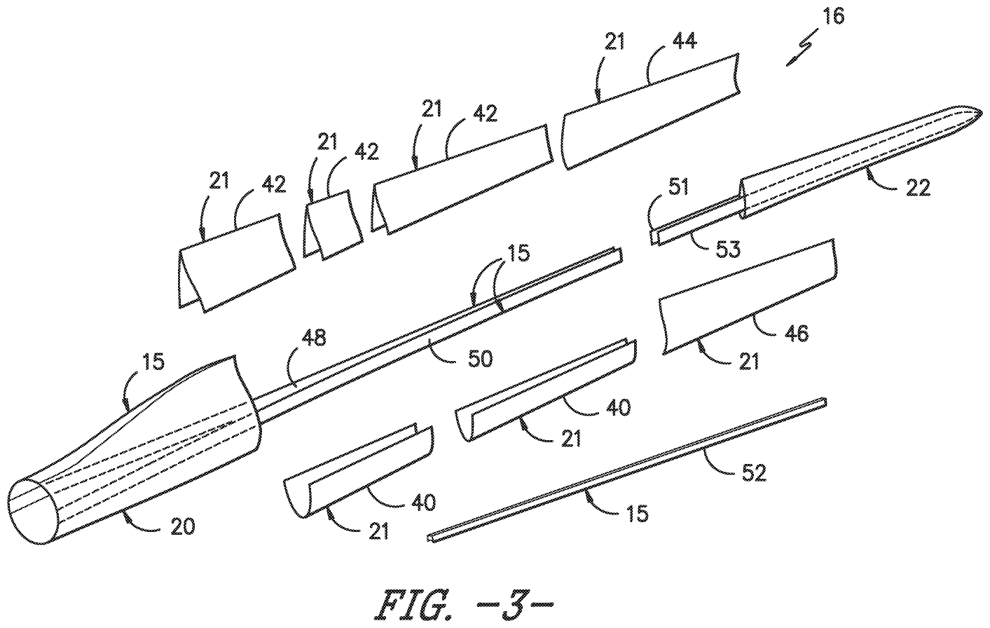

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Thus, where the blade segments 21 are constructed at least partially of a thermoplastic material, adjacent blade segments 21 can be welded together along the seams 36, 38, 54, which will be discussed in more detail herein. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015, entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the length or span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

In addition, the spar caps 48, 50, 51, 53 may be constructed of any suitable materials, e.g., a thermoplastic or thermoset material or combinations thereof. Further, the spar caps 48, 50, 51, 53 may be pultruded from thermoplastic or thermoset resins. As used herein, the terms “pultruded,” “pultrusions,” or similar generally encompass reinforced materials (e.g., fibers or woven or braided strands) that are impregnated with a resin and pulled through a stationary die such that the resin cures, solidifies, or undergoes polymerization. As such, the process of manufacturing pultruded members is typically characterized by a continuous process of composite materials that produces composite parts having a constant cross-section. Thus, the pre-cured composite materials may include pultrusions constructed of reinforced thermoset or thermoplastic materials. Further, the spar caps 48, 50, 51, 53 may be formed of the same pre-cured composites or different pre-cured composites. In addition, the pultruded components may be produced from rovings, which generally encompass long and narrow bundles of fibers that are not combined until joined by a cured resin.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015, entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

Referring now to FIGS. 8 through 14, the present disclosure is directed to composite structures 100 and methods for manufacturing and/or assembling same, such as the rotor blade panels 21 (and/or any additional rotor blade components) described herein. As such, in certain embodiments, the composite structures 100 described herein may be a pressure side surface, a suction side surface, a trailing edge segment, a leading edge segment, or combinations thereof. In addition, the composite structures 100 of the present disclosure may be manufactured, at least in part, using vacuum infusion, pre-preg materials, three-dimensional (3-D) printing, and/or any other suitable combinations of manufacturing techniques.

3-D printing, as used herein, is generally understood to encompass processes used to synthesize three-dimensional objects in which successive layers of material are formed under computer control to create the objects. As such, composite structures of almost any size and/or shape can be produced from digital model data. It should further be understood that the methods of the present disclosure are not limited to 3-D printing, but rather, may also encompass more than three degrees of freedom such that the printing techniques are not limited to printing stacked two-dimensional layers, but are also capable of printing curved shapes.

Referring particularly to FIG. 8, a flow diagram of one embodiment of a method 150 for manufacturing a composite structure 100 according to the present disclosure is illustrated. In general, the method 150 described herein may be applied to manufacturing the rotor blade panels described herein with respect to FIGS. 1-7. However, it should be appreciated that the disclosed method 150 may be implemented for any other suitable composite structure in any suitable field of technology. Further, FIG. 8 depicts steps performed in a particular order for purposes of illustration and discussion. Those of ordinary skill in the art, using the disclosures provided herein, will understand that various steps of any of the methods disclosed herein can be adapted, omitted, rearranged, or expanded in various ways without deviating from the scope of the present disclosure.

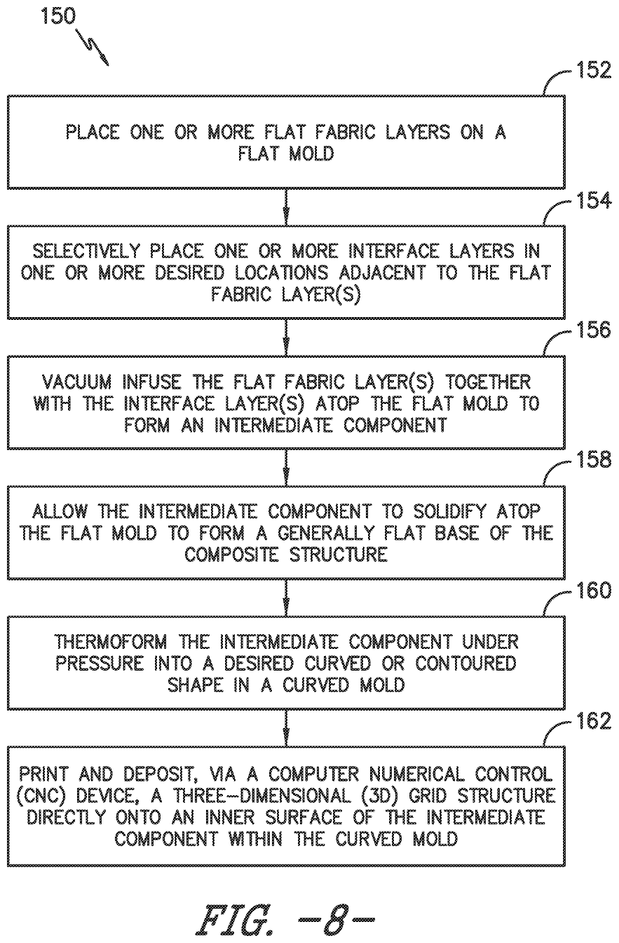

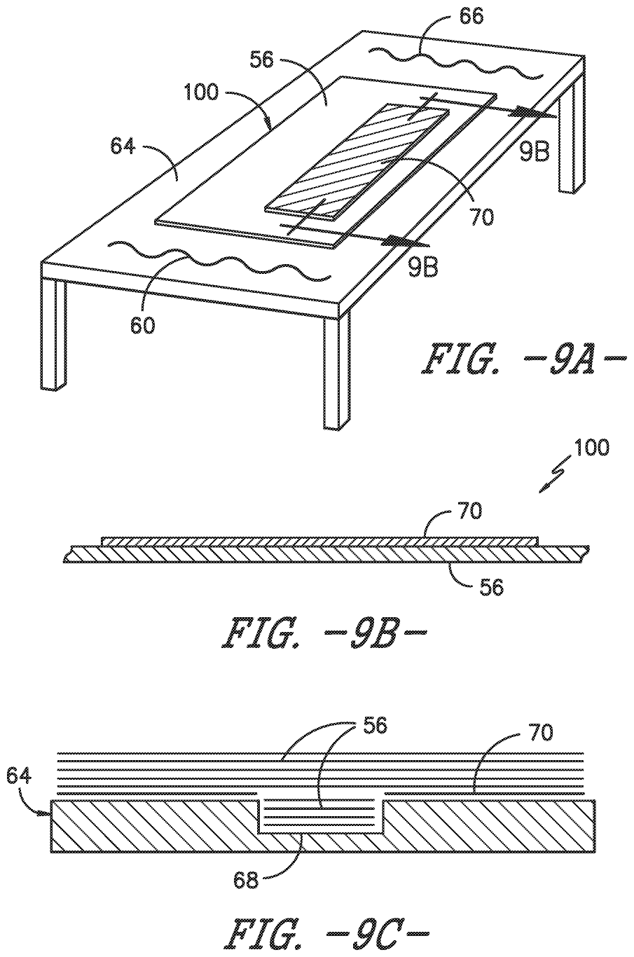

As shown at (152), the method 150 may include placing one or more flat fabric layers 56 on a flat mold 64 or table. For example, as shown in FIGS. 9A and 9B, the flat fabric layer(s) 56 are illustrated adjacent to the flat mold 64. In such embodiments, the flat fabric layer(s) 56 may include glass fabrics (as well as carbon fiber or any type of reinforcing fiber) that are biaxial in most places, but could also include unidirectional, triaxial, quadriaxial fabrics, etc. Accordingly, by placing the generally flat fabric layer(s) 56 on the flat mold(s), efficiency and cycle/cure time is improved.

For example, in conventional blade manufacturing, the blade shell infusion process is done in a dedicated, custom mold for a given blade design. Therefore, conventional blade infusion processes take time to layup all of the materials in the mold, setup for infusion, infuse, cure, and in some cases—post cure. In the methods according to the present disclosure, all of the infusion steps can occur offline on inexpensive flat molds/tables. This allows the dedicated blade shape mold to only be used for the thermoforming and printing process, which is a faster process. Depending on the infusible thermoplastic material used, multiple inexpensive flat molds/tables can be used to produce multiple skins at a pace to keep up with the cycle time of one vacuum forming/printing process. For example, if the vacuum forming and printing cycle time is 30 minutes and the total cycle time to layup, infuse, and cure a skin with this method is 4 hours, then eight skins could be infused simultaneously to maximize the productivity of the vacuum forming/3D printing system.

Moreover, flat mold(s) 64 are more economical than requiring dedicated, uniquely shaped molds. Therefore, the flat mold(s) 64 are easy to reproduce and/or implement at a large scale, thereby allowing multiple flat laminates to be quickly thermoformed (and printed thereon). In such embodiments, vacuum forming and printing can be done in under an hour, such as about 30-45 minutes or less. Moreover, as shown in FIG. 9A, the flat mold(s) 64 described herein may also include integrated heating elements 66 to assist with curing the composite structure. For example, in certain embodiments, the flat mold(s) 64 may include electric resistance heating, heated working fluid, a hot air system, or may be sized such that the table(s) can be placed inside a large oven or heating system.

In alternative embodiments, as shown in FIG. 9C, rather than being completely flat, the mold 64 may be modified to have a trough 68 designed to accommodate various plies, such as the spar plies described herein. This enables the spar plies to be laid down in the trough, the print-side film to be laid down on the mold surface and the remaining skin plies to be laid atop both. Then, an optional UV film (as described herein below) may be laid thereon with a leave-in-place flow media therebeneath if a UV film is used.

Referring back to FIG. 8, as shown at (154), the method 150 may include optionally selectively placing one or more interface layers 70 in one or more desired locations adjacent to the flat fabric layer(s) 56. In such embodiments, as shown in FIG. 9A, since the fabric layer(s) 56 are generally flat, there is the opportunity to apply various layups with fiber-based fabrics that do not have to extend the entire length and/or width of the overall structure. Further, the interface layer(s) 70 may be placed so as to form part of the inner or outer surfaces of the blade panel. As such, the composite structures described herein can be customized with varying materials and/or optimized for weight. In addition, or alternative to the interface layer(s) 70, the composite structure 100 may also include resin-rich thermoplastic surface (such as Elium®) at the print interface side. Moreover, the composite structure 100 may further include another film on the aerodynamic surface of the blade shell.

In particular embodiments, as an example, the interface layer(s) 70 may be placed at locations in which one or more grid structures 62 will be printed thereto, which is described in detail herein below. In another embodiment, the interface layer(s) 70 may be placed at bondline areas of the rotor blade 16, such as the trailing edge bond line, or any other bondline in the blade 16 where improved adhesion is desired. In such embodiments, in cases where a preferred adhesive does not sufficiently bond with the infused thermoplastic matrix (such as Elium®), one or more of the interface layers 70 can be co-infused at the desired bondline, which becomes the interface that bond paste or other suitable adhesive can be used to bond the blade components together. Thus, in an example embodiment, a thin precured epoxy fiberglass layer may be provided in the inner surface of bondline areas to provide improved adhesion after thermoforming. In certain embodiments, this technique may utilize any suitable film or precured composite material can be bonded to the infusible thermoplastics described herein. This allows for further use of adhesives that might not otherwise work well with infusible thermoplastics. Applying these individual layers in discrete locations offers highly customized options. Moreover, since these layers are placed on the flat mold(s), manufacturing is generally easier and simpler to complete, thereby making the process easier to automate.

In certain embodiments, the interface layer(s) 70 described herein may be preferably made of PETG. In other embodiments, the interface layer(s) 70 may be made of any workable combination of polyurethane (PU), polycarbonate (PC), and/or polymethyl methacrylate (PMMA) (such as Elium® resin). Moreover, in an embodiment, the thickness of the interface layer(s) 70 may be preferably in the range of about 0.25 millimeters (mm) to about 0.75 mm.

In addition, such interface layer(s) 70 may be placed at location that form an inner surface of the formed fabric layer(s) 56. Accordingly, in such embodiments, the inner surface eventually coincides with the print-side surface (i.e., the surface to which the grid structure is printed thereto) and may include a resin-rich surface. For example, in an embodiment, one or more thermoplastic films made from a neat thermoplastic resin or resin blend (i.e., having little to no significant fiber or fillers included therein) may be used to form the resin-rich print-side surface of the skin(s). In another embodiment, one or more multilayer thermoplastic resin films having two or more distinct thermoplastic resin layers may be used to form the resin-rich print-side surface of the fabric layer(s) 56. In such embodiments, the film(s) may be laid atop the flat mold on the top and/or bottom layer of the fabric layup prior to infusion. During infusion, the thermoplastic film(s) may be cured to either the top and/or the bottom of the laminate stack. In further embodiments, such thermoplastic films do not have to encompass the entire top or bottom surface of the print-side surface, but may be selectively used only where needed to save cost or weight.

In alternative embodiments, a resin-rice surface can also be created using the infusion process (i.e., without the use of thermoplastic films) to create an intentionally resin-rich area (i.e., a higher resin volume fraction at the to be printed interface compared to the remainder of the laminate) on the print-side surface. In such embodiments, the greater the resin volume fraction at the print interface, the greater the amount of free thermoplastic resin available to easily flow and diffuse into the printed grid material later in the process. Various techniques may be used for delivering the resin-rich surface during infusion include, for example, using high loft low weight fiber based fabrics that allow for a high resin volume fraction after infusion. In addition, in an embodiment, care should be taken to select fabrics that are compatible with the infusible thermoplastic and are structural materials (such as glass fiber based) that will not introduce unnecessary defects or structural weakness in the composite structure. Other techniques to deliver a resin-rich surface include using a textured vacuum bag, peel ply, veil, and/or any other consumables that will promote additional resin flow on the desired surface and that when removed leave a suitable surface finish and resin content for sufficient bonding to the printed surfaces described herein.

Referring back to FIG. 8, as shown at (156), the method 150 may further include vacuum infusing the flat fabric layer(s) 56 together with the interface layer(s) 70 (if included) atop the flat mold 64 to form an intermediate component. For example, in one embodiment, the fabric layer(s) 56 may be infused with an infusible thermoplastic (such as PMMA or Elium® resin). In other embodiments, the fabric layer(s) 56 may be infused via any suitable infusion process with any workable combination of PMMA (e.g., Elium® resin in which VARTM is used), PET, PU, epoxy, and/or other thermoset materials.

In addition, as shown at (158), the method 150 may further include allowing the intermediate component 75 to solidify or cure atop the flat mold 64 to form a generally flat base of the composite structure 100. Accordingly, the cured intermediate component 75 has a surface with a resultant surface finish that is suitable, e.g., for a wind turbine rotor blade. In alternative embodiments, where the aerodynamic outer surface is not cured against the flat mold, the resultant surface finish may be rougher than desired, i.e., for a typical wind blade. In such embodiments, the method 150 may include using a thermoplastic film on this surface (preferably UV stabilized and in blade color) or providing a veil fabric on the surface (i.e., underneath the thermoplastic film or used without a film).

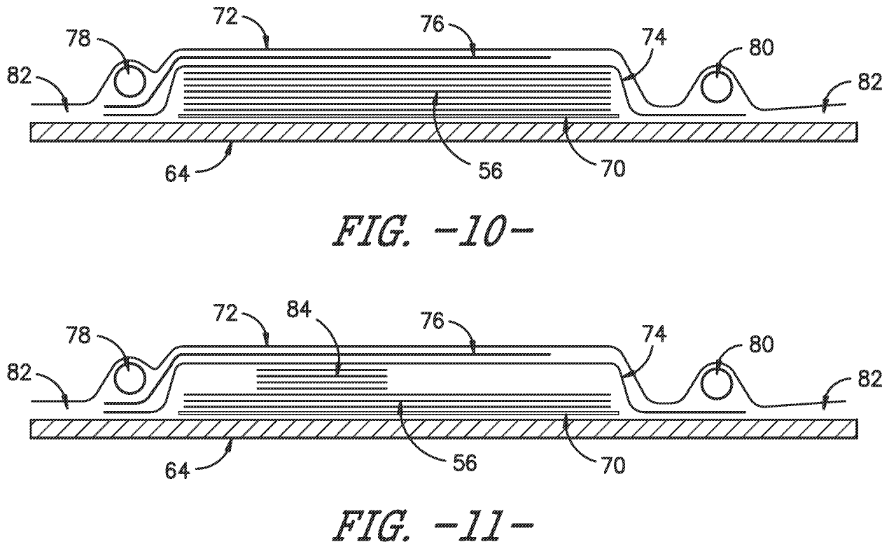

More particularly, in an embodiment, as shown generally in FIGS. 10-13, vacuum infusing the flat fabric layer(s) 56 together with the interface layer(s) 70 atop the flat mold 64 may include using VARTM (Vacuum Assisted Resin Transfer Molding). In particular, FIG. 10 illustrates a basic set up of the vacuum process described herein. As shown, the flat fabric layer(s) 56 together with one or more interface layers 70 atop the flat mold 64 can be covered with a vacuum bag 72. A peel ply 74 may also be placed atop the flat fabric layer(s) 56 as desired. Furthermore, a flow media 76 can be provided atop the skins 56 to improve resin flow by providing a flow promoting material that is easier to flow through (versus the fiber reinforced fabrics) to allow greater flow distance to be achieved before the material beings to gel or cure. Accordingly, during the infusion process, resin can be injected through inlet 78 and pulled across the skins 56 and interface layer(s) 70 to an outlet 80. In addition, as shown, the system is sealed via one or more seals 82, optionally one on each side of the skins 56.

FIG. 11 illustrates another embodiment of the vacuum infusion process in which the layers may have varying sizes. For example, as shown, the interface layer 70 does not cover the entire outer surface of the composite structure 100. Rather, in certain embodiments, the interface layer 70 may only need to be placed, as an example, where the grid structure 62 as described herein will be printed. In addition, as shown in the embodiment of FIG. 11, the composite structure 100 may also include one or more spar plies 84 placed adjacent to the fabric layer(s) 56.

Moreover, in particular embodiments, the interface layer(s) 70 described herein, as an example, may be constructed of PETG, PMMA, ABS, or PC material. In additional embodiments, the infusible thermoplastic resin and the materials used to form the interface layer(s) 70 can be selected such that the materials are compatible with each other (i.e., the infusible thermoplastic resin does not attack the interface layer(s) during the infusion or curing process). For example, in one embodiment, the monomers in certain infusible resin systems can behave as a solvent and dissolve other materials, including many thermoplastics. Though some amount of attack can be beneficial to promoting a good chemical bond between the infused thermoplastic and another material (including a thermoplastic film), too much attack can alter the structure of the interface layer for use in its intended purpose in successive steps. As such, in an embodiment, thermoplastic films, such as PMMA (acrylic) and polycarbonate, may be used with Elium® resin. In certain instances, the presence of solvents, liquid monomers, and/or other constituents in the liquid thermoplastic resin systems may react with certain thermoplastic films. Therefore, in the present disclosure, certain manufacturing steps are completed to ensure such reactions do not occur. For example, in an embodiment, the method 150 may include increasing the catalyst level reduce the curing cycle time and/or post curing the laminate immediately after gelation to ensure complete curing of all reactive components and minimize attack to the thermoplastic film. In another embodiment, the method 150 may also include curing the composite structure 100 by other means, alone or in combination, e.g., using UV energy, additional heat or a combination of both.

In certain embodiments, the interface layer(s) 70 may also include materials having a higher Tg (i.e., glass transition temperature) to improve creep performance between the layer(s) and the printed material. For example, in one embodiment, the Tg of the material may be greater than about 70° C., or more preferably about 90° C. Moreover, in further embodiments, the present disclosure may include infusion techniques to deliver a resin rich or neat surface at the print interface. For example, in certain embodiments, the interface layer(s) 70 may include PMMA film and polycarbonate plus multilayer films. Accordingly, the print surface can be selected to be compatible with the grid material such that the surfaces are printable/weldable. In one embodiment, a resin-rich Elium® surface, PMMA, or PC film can be used, with the grid material being a blend of PBT/PC with an appropriate amount of glass fiber loading. In such embodiments, the mold temperature may also be increased to ensure the PC film is heated sufficiently above its Tg such that welding can occur. Further, in such embodiments, the PBT concentration may be kept low to retain recycling compatibility and also to not interfere with the welding to resin-rich surfaces.

In additional embodiments, the thickness of the interface layer(s) 70 may be increased if such layers are susceptible to attack. By increasing the layer thickness, the surface that will be printed on in a later step may be unaffected by the chemical attack from the infused resin/catalyst of the infusible thermoplastic that affects the surface in contact with the resin/catalyst. For example, with PETG film as an interface film, unacceptable degradation that affects bonding with printed grid material has been witnessed at 0.25 mm and less. Therefore, in such embodiments, the thickness of the PETG film may be 0.5 mm or more or 0.2 mm or more. By using this technique, chemical attack is not prevented, the thickness is increased to a point where allows a less chemically resistant interface material to be used successfully.

For example, in particular embodiments, the vacuum infusion of the interface layer(s) typically occurs at about 25° C., followed by a rapid curing at about 25° C. with further application of either external heat or a combination of heat and ultraviolet (UV) energy. Rapid cured skin with the interface layer patches may be further post-cured, typically at 90° C. Each of these methods are intended to cure the composite structure as quickly as possible to minimize any attack on the thermoplastic film.

The above embodiment describes how techniques are used to rapid cure the infused thermoplastic resin in order to improve its compatibility with any interface layers prior to 3-D printing thereon. In additional embodiments, the methods of the present disclosure may also ensure that infusible thermoplastic systems (such Elium®, etc.) are able to withstand the temperatures to which such materials are exposed during either the thermoforming or 3-D printing process. For example, in certain instances, such systems can generate porosity and start to lose mechanical integrity at such temperatures if both the materials and process are not well understood and applied correctly. In order to achieve this high temperature resilience, the infusible thermoplastic resin can be prepared using a variety of methods. In one embodiment, the infusible thermoplastic resin can be vacuum degassed after or during mixing but prior to infusion. In another embodiment, the methods of the present disclosure may include using a catalyst that does not contain phthalates. In such embodiments, the catalyst can be selected to ensure that it does not contain elements that would encourage or promote outgassing. In yet another embodiment, the methods of the present disclosure may include drying the cured laminate prior to high temperature exposure to avoid any moisture from vaporizing in the resin. In an embodiment, for example, a low-moisture content catalyst, such as Perkadox GB50L, may be used having a moisture content of less than about 0.5% moisture. In such embodiments, to maximize temperature resistance of the laminate, the low-moisture content catalyst mixture can be vacuum degassed the before infusion. Therefore, the catalyst is configured to reduce both phthalates and moisture. All of the above provides a method that has the ability to run these laminates to as high as 160° C. without degradation.

Example catalysts may include, for example, ethylene glycol dibenzoate (such as Perkadox GB50X or Perkadox GB50L from Nouryon) when used with an infusible resin such as Elium®. The resulting cured laminate which has been degassed and includes well-selected a catalyst (such as Perkadox GB50X and GB50L from Nouryon) generally has much lower levels of outgassing when compared to a laminate which is made with a catalyst containing dicyclohexyl phthalate (such as Perkadox CH-50X from Nouryon). The later catalyst type containing impurities in some of its components, such as the phthalate that start to seed porosity.

In additional embodiments, where a given thermoplastic provided on the print-side surface is susceptible to chemical attack from the infusible thermoplastic resin system, and using a multilayer film can protect the thermoplastic. This enables a choice of a more compatible film for the infusion resin, coupled with the desired print-side surface thermoplastic to be used. As used herein, multilayer films can include two thermoplastics co-extruded or laminated together. In another embodiment, a third tie layer may be needed between the print-side layer and infusion side layers depending on the chosen thermoplastics.

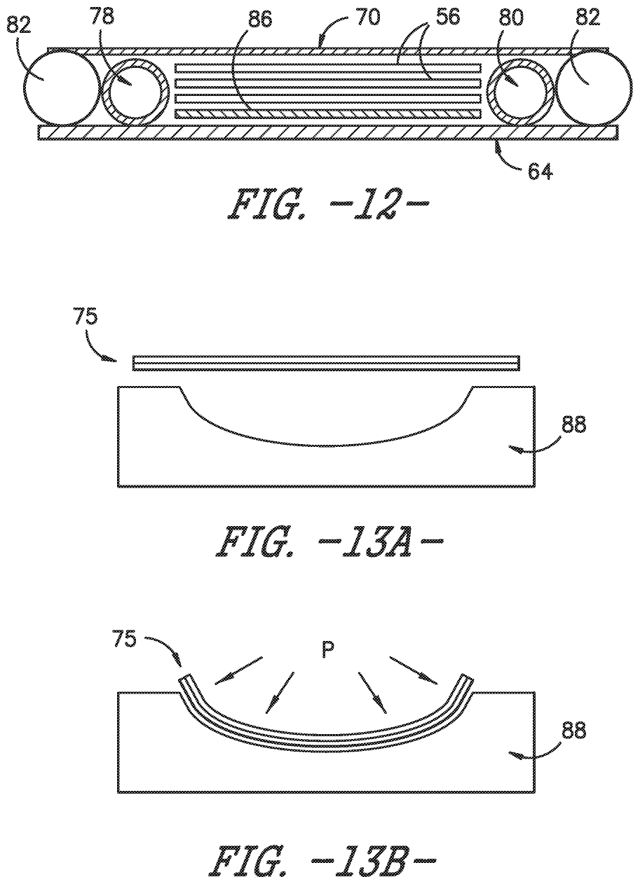

In still further embodiments, in addition to the print-side surface, the composite structure 100 may also be constructed of a UV stable, pigmented layer that corresponds to a typical blade color (such as RAL 7035). For example, as shown in FIG. 12, the composite structure 100 may be formed with a UV stable, pigmented layer 86 that corresponds to the desired blade color. In another embodiment, it should be understood that the interface layer(s) 70 and the pigmented layer 86 may be reversed.

Thus, the pigmented layer may correspond to the aerodynamic surface of the final component. As mentioned, in one embodiment, a preferred film for the outer layer should be compatible with the infusion resin systems or should include methods to protect the film from attack. In certain embodiments, suitable films may include acrylic, PET, and polycarbonate based systems, as just a few examples. These films may also include multilayer configurations as described herein. In particular embodiments, such films can be easily included as part of the composite structure due to the use of the flat molds described herein, which provide films not adversely attacked during the infusion and curing process. In addition, such films provide a suitable bond to the cured laminate and results in a structure that does not need to be painted after molding. If formed without a UV-stable layer, the surface of the composite material may be painted, e.g., with an acrylic-based paint that will also flow at vacuum forming temperatures (for example, greater than 110° C.).

Additional considerations may also be considered when infusing multiple thermoplastic films or a thermoplastic film and the mold surface. In such instances, it may be difficult to achieve proper infusion resin flow for the entire length of the part, particularly for large composite structures such as wind turbine rotor blades. Thus, as mentioned, various consumables can use flow media 76 to improve the resin flow by providing a flow promoting material that is easier to flow through (versus the fiber reinforced fabrics) to allow greater flow distance to be achieved before the material beings to gel or cure. Once the resin begins to gel or cure, viscosity increases which slows and/or stops the infusion process. Flow media is often a non-structural material and is not desirable to be left in the final structure. Thus, when infusing a thermoplastic film with fiber reinforced fabrics (and said film is intended to be left in the final structure), a flow media cannot be used if it would create a defect or otherwise weaken the laminate in an undesirable way. Accordingly, to prevent this issue, the method 150 may also include texturing or calendaring the film to promote flow through small channels in the film.

For example, in one embodiment, such channels or passages can be created by using calendar rolls to emboss the desired texture when the film is created. In another embodiment, the method 150 may include using a fiber-based flow media that can be left in the composite structure after infusion. Provided the media bonds well with the infusion resin, improves flow, and does not cause undesirable reduction in physical properties of the laminate, fabrics such as continuous strand mat (CSM) or continuous filament mat (CFM) can be used. In particular embodiments, the method 150 should also include ensuring the sizing on the fiber is compatible with the infusion resin and preferably using a structural filament (such as glass) to reduce stiffness to weight ratio penalty.

In still another embodiment, the method 150 may include utilizing a two-step infusion process or more. In such embodiments, the outer skin layers of the flat skin(s) may be infused in a first step, along with the thermoplastic film intended for the print-side surface to be placed against the flat mold first with fabric plies on top, removable flow media as needed, and a vacuum bag. After curing, the composite structure may be removed and overturned. Spar plies can then be laid up in the appropriate area as needed and infused directly to the previously-cured skin(s). In certain embodiments, the thermoplastic film may be used only as a patch in one or more areas that will be printed on in a later process step and is not present in areas where the secondary plies will be infused. The infusion of the plies to the previously-cured skin(s) can be completed using the flat mold or similar by turning the structure on an opposing side thereof and infusing the plies directly to the now top surface of the structure in the desired area, e.g., via vacuum bagging directly to the previously-cured skin(s). The infusion resin can then cure and bond to the previously-cured fabric layer(s) 56.

In alternative embodiments, once the composite structure is vacuum formed as described later herein, additional fiber based plies can then be infused within the curved blade mold, preferably on top of the composite structure, just before printing thereto. This can be advantageous if there are a substantial number of plies that might be difficult to effectively vacuum form into shape from a precured flat panel. In addition, in such embodiments, curing in the blade mold allows the secondary plies to be cured into desired final shape. Another embodiment may also include using heat from the vacuum-forming blade mold to help cure and post-cure the extra plies. This step may also be completed during the printing cycle if desired.

In certain embodiments, the vacuum infusion process described herein may eliminate the use of a consumable (or re-usable) vacuum bag. For example, as shown in FIG. 12, the print-side thermoplastic film 70 may also double as a vacuum bag (such that vacuum bag 72 can be eliminated). Rather, in such embodiments, the desired thermoplastic film 70 may be used as the vacuum bag, thereby reducing waste in the manufacturing process. In this embodiment, as shown, the thermoplastic film 70 may extend beyond the reinforcing fabrics so the perimeter of the infusion can be sealed off to the mold surface using appropriate securement means 82, such as adhesive, tape (e.g., Tacky Tape®), etc. In yet another embodiment, the Tacky Tape® may be eliminated by using a compatible thermoplastic-film-based adhesive tape made possible due to the flat mold. For example, when using curved molds, Tacky Tape® (i.e., typically butyl rubber) is needed for additional conformance related to curved mold surfaces, pleating of vacuum bags, and/or other effects of vacuum sealing on contoured surfaces. In contrast, the thermoplastic in the compatible tape is recyclable along with the thermoplastics used to make the rest of the structure after infusion and water jet trimming.

As an alternative to the vacuum infusion methods described herein, the method 150 may also include using pre-preg (i.e., “pre-impregnated composite fibers fabrics. Pre-preg fabrics are those that already contain infused resin and catalyst within the fabric but are not yet cured or fully cured, polymerized or fully polymerized. They remain flexible and formable and typically use heat to cure. (Pre-pregs should not be confused with other thermoplastic fiber reinforced sheets that are already polymerized). In such embodiments, the reinforcing fabrics are already impregnated with resin. As such, heat from the flat mold are required to cure the layup after vacuum bagging. In this case, the thermoplastic film can be applied on top and or bottom layers as described herein or can be pre-consolidated to the pre-preg fabric by the prepreg manufacturer. A further improvement may include using multilayer prepregs and laminate either the print side thermoplastic film and/or aerodynamic outer surface thermoplastic film in the prepreg production process. This continuous process method allows for increased cost and labor efficiency via automation. Still another embodiment for a multilayer prepreg with laminated films is to directly waterj et cut the prepreg, place the laminated film directly in the mold and use the heat from the vacuum forming process to cure the laminate. 3-D printing of the grid structure described herein can then be completed as soon as the laminate is sufficiently cured.

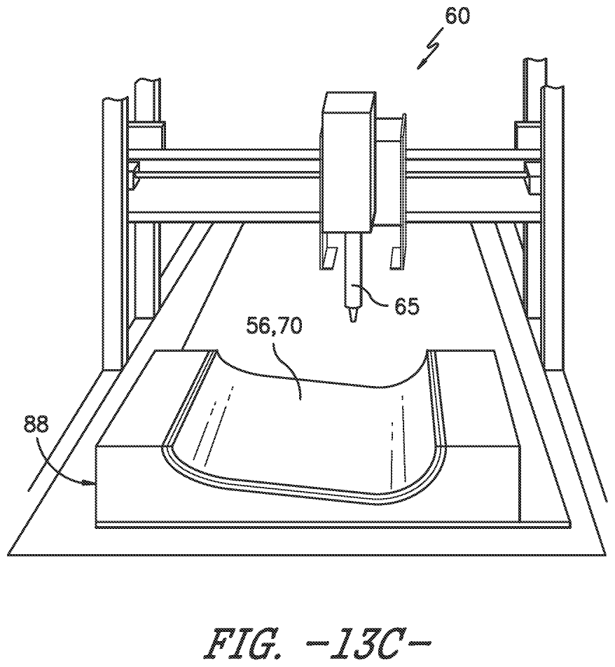

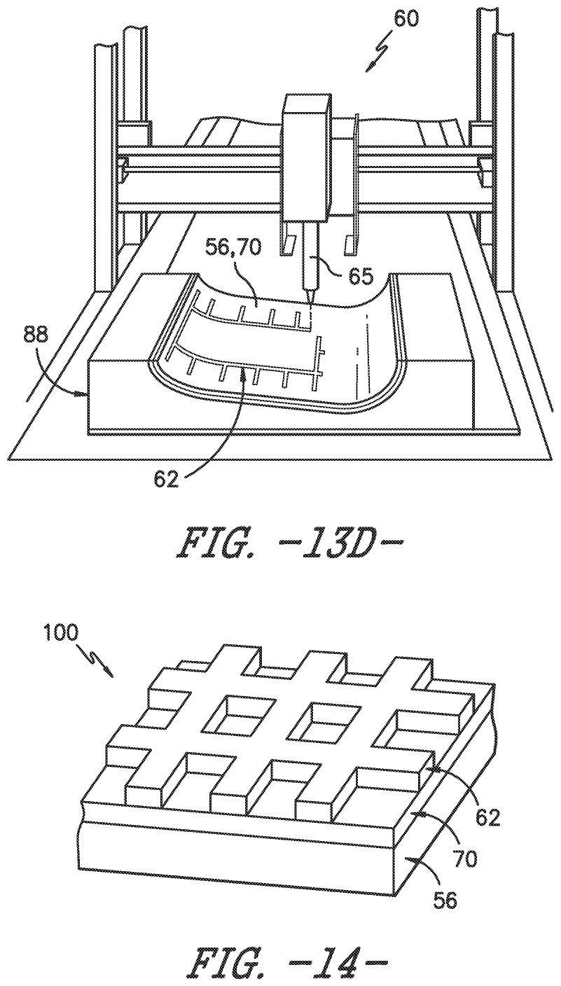

Referring back to FIG. 8, as shown at (160), the method 150 may include subsequently thermoforming the intermediate component 75 under pressure into a desired curved or contoured shape in a mold. For example, as shown in FIGS. 13A and 13B, the intermediate component 75 can be placed in a curved mold 88 via pressure, such that the intermediate component 75 is forced into a curved shape. In an embodiment, when the intermediate component 75 is first placed on the mold 88, the mold 88 may be cold or warm, but is preferably cool enough to be safe for operators. After the intermediate component 75 secured in the mold 88, vacuum is applied and the part is shaped cold. Then, the mold can be heated to further form the desired shape of the intermediate component 75. For example, in an embodiment, the mold 88 may be heated to a temperature in the range of about 100° C. to about 200° C.

Once the intermediate component 75 is formed into the desired shape, referring back to FIG. 8 as shown at (162), the method 150 then includes printing and depositing, via a computer numerical control (CNC) device 60, a three-dimensional (3D) grid structure 62 directly onto an inner surface of the intermediate component 75, e.g., within the mold 88. More specifically, in certain embodiments, as shown in FIGS. 13C and 13D, the CNC device 60 is configured to print and deposit the grid structure 62 onto the inner surface of the intermediate component 75 so as to have any suitable shape. In certain embodiments, wherein the intermediate component 75 and the grid structure 62 are formed of a thermoplastic matrix, the CNC device 60 may immediately print the grid structure 62 thereto as the forming temperature of the intermediate component 75 and the desired printing temperature to enable thermoplastic welding/bonding can be the same. More specifically, in particular embodiments, before the intermediate component 75 has cooled from forming, (i.e., while still hot or warm), the CNC device 60 is configured to print and deposit the grid structure 62 onto the inner surface of the intermediate component 75. For example, in one embodiment, the CNC device 60 is configured to print and deposit the grid structure 62 onto the inner surface of the intermediate component 75 before the structure has completely cooled. In addition, in another embodiment, the CNC device 60 is configured to print and deposit the grid structure 62 onto the inner surface of the intermediate component 75 when the structure has partially cooled. Thus, suitable materials for the grid structure 62 and the intermediate component 75 can be chosen such that the grid structure 62 bonds to the intermediate component 75 during deposition. Accordingly, the grid structure 62 described herein may be printed using the same materials or different materials.

In addition, the method 150 of the present disclosure may include treating the intermediate component 75 to promote bonding between the intermediate component 75 and the grid structure 62. More specifically, in certain embodiments, the intermediate component 75 may be treated using flame treating, plasma treating, chemical treating, chemical etching, mechanical abrading, embossing, elevating a temperature of at least areas to be printed on the intermediate component 75, and/or any other suitable treatment method to promote said bonding. In additional embodiments, the method 150 may include forming the intermediate component 75 with more (or even less) matrix resin material on the inside surface to promote said bonding. In additional embodiments, the method 150 may include varying the skin thickness and/or fiber content, as well as the fiber orientation.

Further, the method 150 of the present disclosure may include varying the location and/or design of the grid structure 62 (e.g., materials, width, height, thickness, shapes, etc., or combinations thereof). As such, the grid structure 62 may define any suitable shape so as to form any suitable structure component, such as the spar cap 48, 50, the shear web 35, or additional structural components of the rotor blade 16. For example, as shown in FIG. 13D, the CNC device 60 may begin printing the grid structure 62 by first printing an outline of the structure 62 and building up the grid structure 62 in multiple passes. As such, extruders 65 of the CNC device 60 can be designed have any suitable thickness or width so as to disperse a desired amount of resin material to create the grid structure 62 with varying heights and/or thicknesses. Further, the grid structure 62 size can be designed to allow local buckling of the face sheet in between rib members thereof, which can influence the aerodynamic shape as an extreme (gust) load mitigation device.

In additional embodiments, the grid structure 62 may be formed of any suitable thermoset or thermoplastic material described herein. For thermoset resins, the resin may be reinforced by any suitable fiber reinforcement. For thermoplastics, in another embodiment, the grid structure 62 may be formed of any suitable blend of one or more thermoplastic materials described herein. For example, in one embodiment, the grid structure 62 may be printed onto or otherwise secured to the outer skins 56. Further, the thermoplastic or thermoplastic blend grid material may be fiber reinforced with any suitable fiber material. For example, in an embodiment, the thermoplastic or thermoplastic blend may be glass reinforced, e.g., up to 60% loading by weight. Further thermoplastics and/or thermoplastic blends may be selected for thermal welding and/or adhesive bonding compatibility with the selected interface surface of the outer skins 56. For example, for a skin with a print interface surface comprising PMMA (which can also include Elium®), the grid material may include PMMA (which can also include Elium®), polycarbonate, or ABS. Further, skin interface materials may be selected based on the preferred grid material selection. By way of example, if a predominantly PBT grid formulation is preferred, the skin interface material may be selected to include one or more of PET, PETG, PBT and/or other thermoplastic polyesters to support welding compatibility and printing directly of the grid structure 62 to the skin interface.

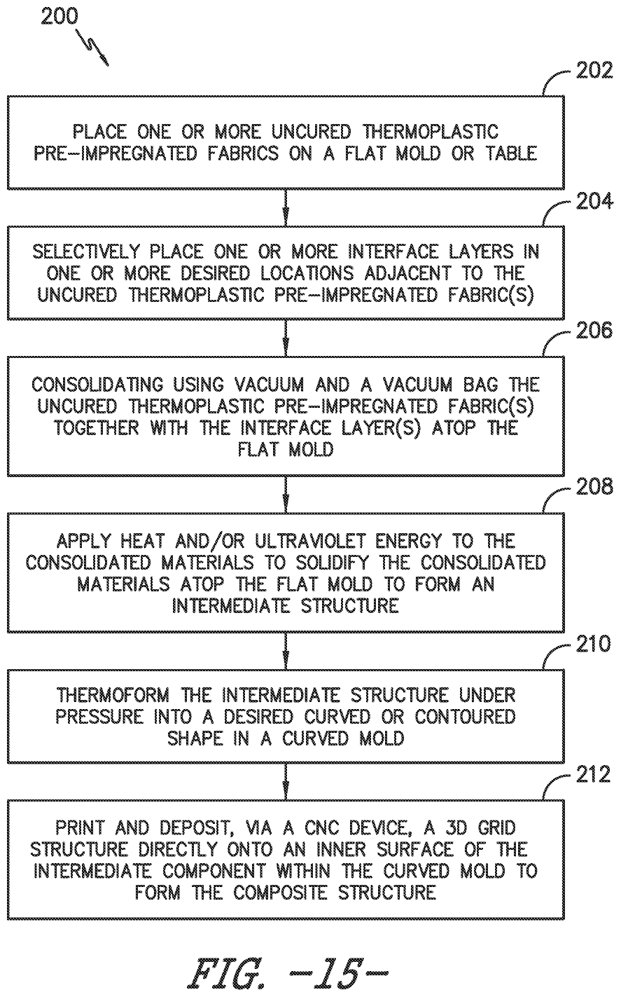

In another embodiment, the grid structure 62 and the intermediate component 75 (along with its interface layers described herein) may be further affixed to each other by means of secondary stiffening (or bonding or securing) structures. In one embodiment, for example, the secondary stiffening (or bonding or securing) structure may be made of fiber reinforced plastic (FRP). As shown in FIG. 14, a perspective view of one embodiment of the composite structure 100 formed according to the present disclosure is illustrated and includes a three-layer configuration.

Another aspect of this embodiment may include applying pre-pregs into the mold at temperatures low enough not to cause premature curing during layup and the vacuum infusion process. Such a method 200 is illustrated in FIG. 15. In particular, as shown, FIG. 15 illustrates a flow diagram of one embodiment of a method 200 for manufacturing a composite structure 100 according to the present disclosure is illustrated. In general, the method 200 described herein may be applied to manufacturing the rotor blade panels described herein with respect to FIGS. 1-7. However, it should be appreciated that the disclosed method 200 may be implemented for any other suitable composite structure in any suitable field of technology. Further, FIG. 15 depicts steps performed in a particular order for purposes of illustration and discussion. Those of ordinary skill in the art, using the disclosures provided herein, will understand that various steps of any of the methods disclosed herein can be adapted, omitted, rearranged, or expanded in various ways without deviating from the scope of the present disclosure.

As shown at (202), the method 200 includes placing one or more uncured thermoplastic pre-impregnated fabrics (i.e., pre-pregs) on a flat mold or table. For example, in an embodiment, the uncured thermoplastic pre-impregnated fabric(s), which may be flat, may be manually placed atop the flat mold. In alternative embodiments, the uncured thermoplastic pre-impregnated fabric(s) may be dispensed from a continuous laminating machine which combines all of the thermoplastic prepreg layers. Therefore, the dispensed thermoplastic pre-impregnated fabric(s) may be uncured or partially cured/b-staged sheets that are dispensed directly from the continuous laminating machine and into the flat mold for further processing.

Further, as shown at (204), the method 200 includes selectively placing one or more interface layers (such as a thermoplastic film) in one or more desired locations adjacent to the uncured thermoplastic pre-impregnated fabric(s). As shown at (206), the method 200 includes consolidating using vacuum and a vacuum bag the uncured thermoplastic pre-impregnated fabric(s) together with the interface layer(s) atop the flat mold. As shown at (208), the method 200 includes applying heat and/or ultraviolet energy to the consolidated materials to solidify the consolidated materials atop the flat mold to form an intermediate structure. As shown at (210), the method 200 includes thermoforming the intermediate structure under pressure into a desired curved or contoured shape in a curved mold. As shown at (212), the method 200 includes printing and depositing, via a CNC device, a 3D grid structure directly onto an inner surface of the intermediate component within the curved mold to form the composite structure.

In certain embodiments, it may also be preferable that when adding pre-preg(s) to an existing skin in the mold, the skin is preferably already formed cold or at temperatures low enough to not cause premature curing in the mold to take shape. In another embodiment, the thermoplastic skin may be vacuum formed first, then cooled enough to allow for applying the pre-preg on top of the formed skin and then heating to a temperature suitable for curing the pre-preg and/or printing onto at least a portion of the thermoplastic skin. In another embodiment, by using pre-preg materials, a thermoset-based resin can be easily used in part or all of the skin. The pre-preg layers can be hand laminated to a portion of a thermoplastic skin and curing can take place under a dedicated vacuum bag and can cure using the heat transferred through the skin from the heated mold during the vacuum forming process and/or the printing process. In one embodiment, this step may be completed after the printing process while still on the mold. Alternatively, this step can be carried out in a later step on a separate heated mold.

In yet another embodiment, a secondary infusion can be used to add additional layers during the vacuum infusion and/or printing steps. In such embodiments, solidified fabric layers can be added on top of the composite structure in the mold. Typical vacuum bagging can then be applied to pull vacuum during the mold heating process to a temperature suitable for curing and/or printing. The infusion process can be carried out before or after the printing process. In one embodiment, the infusion process is performed after the main skin is cold formed in the mold and then heat from the vacuum forming and printing process can be used to cure the infused plies faster. Infusion typically should not be performed at temperatures that would cause the resin system to cure during the infusion process. These embodiments also allow for the skin to have selected areas that are thermoset based where desired. These techniques can work for any infusible resin systems, including both thermosets and thermoplastics.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of manufacturing a composite structure, the method comprising:
placing at least one fabric layer atop a generally flat mold;
placing at least one thermoplastic film in one or more desired locations adjacent to the at least one fabric layer;
co-infusing or co-bonding the at least one fabric layer and the at least one thermoplastic film together atop the generally flat mold to form at least one skin layer having a resin-rich, print-side surface, wherein the at least one skin layer comprises a thermoplastic resin after curing;
forcing the at least one skin layer into a desired shape via a curved mold;
printing and depositing, via an extruder of a computer numerical control (CNC) device, a liquid thermoplastic material onto the resin-rich, print-side surface of the curved at least one skin layer to form a three-dimensional grid structure thereon; and
at least partially enveloping and securing the grid structure within the at least one fabric layer to form the composite structure.

2. The method of claim 1, wherein co-infusing or co-bonding the at least one fabric layer and the at least one thermoplastic film together atop the generally flat mold to form at least one skin layer further comprises co-infusing the at least one fabric layer and the at least one thermoplastic film together with an infusible thermoplastic resin material.

3. The method of claim 1, wherein the at least one fabric layer further comprises at least one of one or more generally flat, dry fiber fabrics or at least one pre-impregnated composite fibers fabrics already impregnated with resin.

4. The method of claim 1, further comprising securing the at least one fabric layer together with the at least one thermoplastic film atop the generally flat mold to form an intermediate component.

5. The method of claim 4, wherein securing the at least one pre-impregnated composite fibers fabrics together with the at least one thermoplastic film atop the generally flat mold to form the intermediate component further comprises:
applying the at least one thermoplastic film on top or bottom of the at least one pre-impregnated composite fibers fabrics layers; and
heating or ultraviolet curing the generally flat mold to cure the at least one pre-impregnated composite fibers fabrics after vacuum bagging to cure the at least one pre-impregnated composite fibers fabrics.

6. The method of claim 4, further comprising pre-consolidating the at least one pre-impregnated composite fibers fabrics prior to placing the at least one pre-impregnated composite fibers fabrics onto the generally flat mold.

7. The method of claim 4, wherein securing the at least one pre-impregnated composite fibers fabrics together with the at least one thermoplastic film atop the generally flat mold to form the intermediate component further comprises:
applying the at least one pre-impregnated composite fibers fabrics onto the generally flat mold at a temperature low enough not to cause premature curing;
applying the at least one thermoplastic film on top or bottom of the at least one pre-impregnated composite fibers fabrics layers; and
heating or applying ultraviolet energy to the at least one pre-impregnated composite fibers fabrics and the at least one thermoplastic film to form the intermediate component.

8. The method of claim 4, further comprising:
vacuum forming the at least one skin layer;
cooling the at least one skin layer to allow for applying the at least one pre-impregnated composite fibers fabrics to the at least one skin layer; and
heating or applying ultraviolet energy to the at least one skin layer to a temperature suitable for curing the at least one pre-impregnated composite fibers fabrics thereto.

9. The method of claim 4, wherein the at least one thermoplastic film is used as a leave-in vacuum bag, wherein at least a portion of the vacuum bag becomes part of the intermediate component.

10. The method of claim 4, further comprising allowing the intermediate component to solidify atop the generally flat mold to form a generally flat base of the composite structure.

11. The method of claim 4, wherein allowing the intermediate component to solidify atop the generally flat mold further comprises:
rapid curing the one or more flat fiber fabrics together with the at least one thermoplastic film; and
post curing the one or more flat fiber fabrics together with the at least one thermoplastic film.

12. The method of claim 1, further comprising treating the intermediate component using at least one of flame treating, plasma treating, chemical treating, chemical etching, mechanical abrading, embossing, or elevating a temperature of at least areas to be printed on the intermediate component.

13. The method of claim 1, wherein the at least one thermoplastic film comprises a thickness of greater than about 0.2 millimeters (mm).

14. The method of claim 1, wherein, once the composite structure is formed, the method further comprises infusing one or more additional fiber-based plies within the curved mold atop the composite structure before printing and depositing.

15. The method of claim 1, wherein the generally flat mold comprises one or more troughs.

16. The method of claim 1, wherein the at least one thermoplastic film comprises at least one of a glycolised polyethylene terephthalate (PETG), polyethylene terephthalate (PET), acrylonitrile butadiene styrene (ABS), polymethyl methacrylate (PMMA), or polycarbonate (PC).

17. The method of claim 2, wherein the at least one thermoplastic film comprises a multilayer film with a first side of the multilayer film being compatible with the infusible thermoplastic resin material and a second side of the multilayer film being compatible for thermal welding of the grid structure.

18-31. (canceled)

32. A composite structure, comprising:
at least one skin layer constructed of an infusible thermoplastic resin material and one or more fiber fabrics;
at least one thermoplastic film co-infused or co-bonded with the at least one skin layer to form a resin-rich, print-side surface on the at least one skin layer; and
a three-dimensional (3-D) grid structure secured to the resin-rich, print-side surface on the at least one skin layer, the at least one skin layer at least partially enveloping and securing the grid structure,
wherein the grid structure is configured to stabilize the composite structure under at least one of: static local buckling and dynamic global buckling.

33. The composite structure of claim 32, further comprising an ultraviolet-stable film on an outer surface of the at least one skin layer.

34. The composite structure of claim 32, wherein the grid structure is additively printed directly onto the resin-rich, print-side surface on the at least one skin layer.

35-38. (canceled)
